(19) United States
(12) Patent Application Publication
(10) Pub. No.: US 2013/0127705 A1
(43) Pub. Date: May 23, 2013

(54) APPARATUS FOR TOUCHING PROJECTION OF 3D IMAGES ON INFRARED SCREEN USING SINGLE-INFRARED CAMERA

(71) Applicants: Kwang Mo JUNG, Yongin-si (KR); Sung Hee HONG, Seoul (KR); Byoung Ha PARK, Seoul (KR); Young Choong PARK, Seoul (KR); Kwang Soon CHOI, Goyang-si (KR); Yang Keun AHN, Seoul (KR)

(72) Inventors: Kwang Mo JUNG, Yongin-si (KR); Sung Hee HONG, Seoul (KR); Byoung Ha PARK, Seoul (KR); Young Choong PARK, Seoul (KR); Kwang Soon CHOI, Goyang-si (KR); Yang Keun AHN, Seoul (KR)

(73) Assignee: KOREA ELECTRONICS TECHNOLOGY INSTITUTE, Seongnam-si (KR)

(21) Appl. No.: 13/529,659

(22) Filed: Jun. 21, 2012

(30) Foreign Application Priority Data
Nov. 18, 2011 (KR) 10-2011-0120671

(51) Int. Cl. G09G 5/00

(52) U.S. Cl. 345/156

(57) ABSTRACT

The present invention relates to an apparatus for touching a projection of a 3D image on an infrared screen using a single-infrared camera, and more specifically to an apparatus for touching a projection of a 3D image, which projects an image in a free space; recognizes a position touched by a user on the projected image and thus can process an order from a user on the basis of the recognized touched position. The present invention can provide tangible and interactive user interfaces to users. In particular, it is possible to implement various UIs (User Interface), in comparison to an apparatus for touching a projection of a 2D image of the related art, by using the Z-axial coordinate on the infrared screen as the information on depth.

### BACKGROUND OF THE INVENTION

1. Field of the Invention

The present invention relates to an apparatus for touching a projection of a 3d image on an infrared screen using a single-infrared camera, and more particularly to an apparatus for touching a projection of a 3d image on an infrared screen using a single-infrared camera that recognizes a position touched by a user on a projected image, using an infrared LED array and an infrared camera, and can process an order from a user on the basis of the recognized touched position.

2. Description of the Prior Art

Recently, touch screens that can directly receive an input from a screen in order to perform a specific process by locating a specific position on the screen and executing stored software, without using a keyboard, when a hand of a person or an object touches the specific position or a character displayed on the screen, have been widely used.

Touch screens allow a user to easily recognize functions because they can display characters or image information corresponding to the functions in various ways. Therefore, touch screens have been applied for various uses to information machines in subways, department stores, banks and the like, and terminals for vending machines in various stores, common office machines, and the like.

FIG. 1 is a perspective view showing an apparatus for touching a projection of a 3D image on an infrared screen using a multi-infrared camera of the related art.

As shown in FIG. 1, the apparatus for touching a projection of a 3D image on an infrared screen using a multi-infrared camera of the related art is equipped with infrared cameras at left and right sides of an infrared screen and recognizes input from a user indication object by cross-sensing the input from the user indication object with the two cameras.

Therefore, the cost to install two cameras is high and the sensing is correctly performed only when one user indication object is used, so that there is a defect in that an error occurs when one camera senses two user indication objects.

Further, there is a problem in that it is necessary to minutely adjust the angle and the position between the two cameras, and only the portion where the angles of view overlap each other is sensed, so that the sensing region is narrow.

### SUMMARY OF THE INVENTION

Accordingly, the present invention has been made to solve the above-mentioned problems occurring in the prior art, and an object of the present invention is to provide an apparatus for touching a projection of a 3D image on an infrared screen using a single-infrared camera that can recognize a position (X-axial and Z-axial coordinates) touched by a user, on a projection image, and can process an instruction from the user on the basis of the recognized touched position.

In order to accomplish this object, there is provided an apparatus for touching a projection of a 3D image on an infrared screen using a single-infrared camera, which includes: an infrared LED array that generates an infrared screen in a space by emitting infrared rays; a projector that projects an image on the infrared screen; a single infrared camera that is disposed above or under the center portion of the infrared LED array such that a lens faces the infrared screen; and a space touch recognition module that calculates the X-axial and Z-axial coordinates of the infrared screen touched by a user indication object, using an image photographed by the infrared camera.

Further, the apparatus further includes: a pulse generating unit that periodically generates a pulse signal; and an LED driving unit that supplies direct current power to the infrared LED array when a pulse signal is inputted from the pulse generating unit, and cuts the direct current power supplied to the infrared LED array when a pulse signal is not inputted from the pulse generating unit.

Further, the infrared camera takes a photograph when a pulse signal is inputted from the pulse generating unit.

Further, the projector includes: a display module that displays an image; and a projection module that projects an image displayed by the display module to the infrared screen.

Further, the projection module includes: a beam splitter that divides a beam emitted from the display module into two beams; and a spherical mirror that reflects the beam emitted from the display module and reflected from the beam splitter, again to the beam splitter.

Further, the projection module further includes a polarizing filter that converts a beam reflecting off the spherical mirror and traveling through the beam splitter into polarized light.

The present invention relates to an apparatus for touching a projection of a 3d image on an infrared screen using a single-infrared camera, which has an effect of providing a more actual and interactive user interface and providing fun and convenience to a user, so that kiosks to which the present invention has been applied may us such an actual-feeling user interface in the near future.

In particular, it is possible to implement various UIs (User Interface), in comparison to an apparatus for touching a projection of a 2D image of the related art, by using the Z-axial coordinate on the infrared screen as the information on depth.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing an apparatus for touching a projection of a 3D image on an infrared screen using a multi-infrared camera of the related art; FIG. 2 is a perspective view showing an apparatus for touching a projection of a 3D image on an infrared screen using a single-infrared camera according to an embodiment of the present invention;

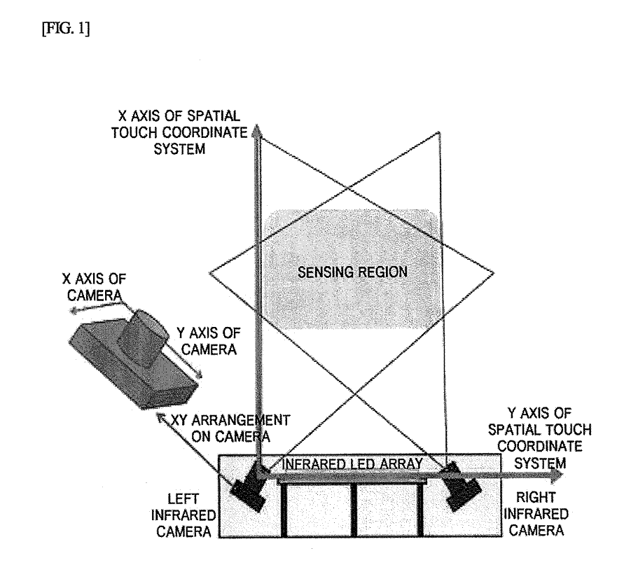

FIG. 3 is a diagram showing the internal configuration of an apparatus for touching a projection of a 3D image on an infrared screen using a single-infrared camera according to an embodiment of the present invention;

FIG. 4 is a diagram illustrating the principle of recognizing a spatial touch in an apparatus for touching a projection of a 3D image on an infrared screen using a single-infrared camera, according to an embodiment of the present invention;

FIG. 5 is a diagram showing the internal configuration of a spatial touch recognition module according to an embodiment of the present invention; and

FIG. 6 is a flowchart illustrating a method of recognizing a touch on a projection image according to an embodiment of the present invention.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

FIG. 2 is a perspective view showing an apparatus for touching a projection of a 3D image on an infrared screen using a single-infrared camera according to an embodiment of the present invention.

As shown in FIG. 2, an apparatus for touching a projection of a 3D image on an infrared screen using a single-infrared camera according to an embodiment of the present invention includes an infrared LED array 110 that generates an infrared screen in a space by emitting infrared rays, an infrared camera 120 that is disposed above or under the center portion of the infrared LED array 110 and takes a photograph of the infrared screen, a projector 130 that projects an image on the infrared screen, a spatial touch recognition module 150 that recognizes a position where a user indication object, for example, a fingertip or a pen, touches the infrared screen, in a gray scale image photographed by the infrared camera 120, and a housing 140 where the components are mounted.

Hereinafter, the configuration of the present invention is described in more detail. First, the infrared screen is a virtual touch screen disposed in a space generated by the infrared LED array 110.

The transverse length of the infrared screen depends on the number of infrared LEDs arranged in a line.

A rectangular frame may be formed around the edge of the infrared screen so that a user can easily recognize the outline of the infrared screen. If it is so, the infrared LED array 110 can be disposed at any one of the upper end, lower end, left side, and right side.

It is preferable that the infrared LED array 110 includes small angle-infrared LEDs. In other words, it is preferable that the infrared beam angle of the infrared LED array 110 has a value within 10 degrees. The infrared LEDs used herein are semiconductor devices that are widely used in the art and thus the detailed description is not provided.

The infrared camera 120, as generally known in the art, which is a device with a built-in filter that cuts off a visible light region and passes only an infrared region, blocks visible light generated from a fluorescent lamp in a room and a three-dimensional image projected on the infrared screen and takes a photograph of only infrared rays in a gray scale image.

Further, the infrared camera 120 is disposed such that the lens faces the infrared screen.

As disclosed in U.S. patent application Ser. No. 6,808,268, it is preferable that the projector 130 includes a display module 137 that displays an image and a projection module that projects an image displayed by the display module to the infrared screen.

The projection module may include a polarizing filter 131, a beam splitter 133, and a spherical mirror 135.

The polarizing filter 131 is disposed at an angle on the screen of the display module 137, and converts a beam reflecting off the spherical mirror 135 and traveling through the beam splitter 133 into polarized light 30 and projects the polarized light to the infrared screen.

Further, the polarizing filter 131 can be implemented by a CPL filter that converts the beam reflecting off the spherical mirror 135 and traveling through the beam splitter 133 into CPL (Circularly Polarized Light).

The beam splitter 133 is disposed between the display module 137 and the polarizing filter 131 in parallel with the polarizing filter 131 and divides the beam 10 generated from the display module 137 into an object beam traveling through the beam splitter 133 and a reference beam reflecting off the beam splitter 133.

The spherical mirror 135 is positioned at the side to which the reference beam 20 reflecting off the beam splitter 133 travels and reflects the reference beam 20, which is generated from the display module 137 and reflected from the beam splitter 133, again to the beam splitter 133.

Further, the spherical mirror 135, as shown in FIG. 2, can be implemented by a concave mirror.

The display module 137 may include an HLCD (High Bright LCD).

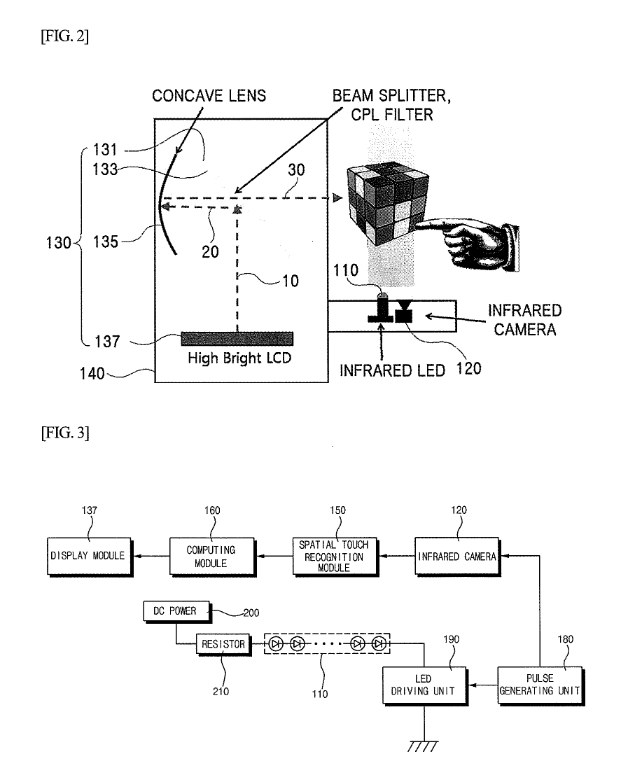

FIG. 3 is a diagram showing the internal configuration of an apparatus for touching a projection of a 3D image on an infrared screen using a single-infrared camera according to an embodiment of the present invention.

The apparatus for touching a projection of a 3D image on an infrared screen using a single-infrared camera according to an embodiment of the present invention may further include, a shown in FIG. 3, a pulse generating unit 180 that periodically generates a pulse signal, an LED driving unit 190 that drives the infrared LED array 110 in response to the pulse signals periodically inputted from the pulse generating unit 180, and a resistor element 180 that is disposed between a DC power 170 and the infrared LED array 110.

In the configuration described above, the pulse generating unit 180 generates pulse signals having a width of 100 μs at every 10 ms, for example.

The LED driving unit 190, in detail, supplies direct current power to the infrared LED array 110 when a pulse signal is inputted from the pulse generating unit 180, and cuts the direct current power supplied to the infrared LED array 110 when a pulse signal is not inputted from the pulse generating unit 180.

That is, the LED driving unit 190 does not keep the infrared LED array 110 turned on, but drives the infrared LED array 110 in response to a pulse signal. The reason that not constant current driving, but pulse driving is necessary is as follows.

An LED is generally operated in a constant driving or a pulse driving way and is brighter when being operated in the pulse driving. That is, the pulse driving is a way that can allow higher current to flow to the LED, that is, can achieve brighter light, in comparison to the constant current driving. However, it is necessary to control time, that is, the pulse width, because the LED may be damaged.

For example, when an LED is driven by a pulse, current of 1 A can flow, but when the LED is driven by constant current, current of only 100 mA can flow. As described above, when an LED is operated in a scheme of pulse driving instead of constant current driving, it is possible to achieve a brightness which is ten times stronger than that of the constant current driving. As a result, it is possible to reduce an error in recognizing a touch due to an external light (for example, sunlight, a fluorescent lamp, and an incandescent electric lamp).

Meanwhile, as a camera takes a photograph when a flash goes off, so does the infrared camera 120 when a pulse signal is inputted from the pulse generating unit 150.

The spatial touch recognition module 150 extracts the positional coordinates of the position that a user indication object enters, from the image photographed by the infrared camera.

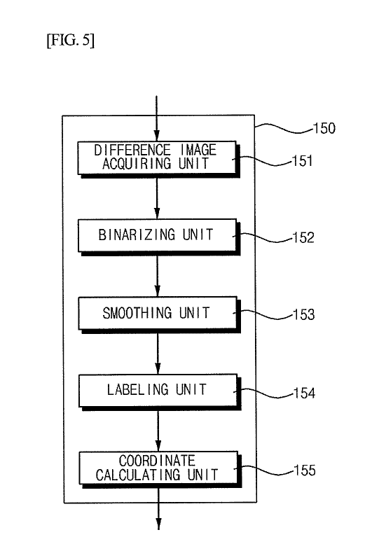

The detailed components of the spatial touch recognition module 150 are described below with reference to FIG. 5.

When receiving the positional coordinates of a user indication object from the spatial touch recognition module 150, a computing module 160 recognizes it as selection of a specific function displayed at the position corresponding to the positional coordinates, on the screen, and performs the corresponding function. For example, when a user puts a finger deep into a fore part of the infrared screen and moves the finger leftward, the computing module 160 recognizes the motion as a drag motion and performs the corresponding function.

Further, when receiving the plurality of positional coordinates from the spatial touch recognition module 150, the computing module 160 performs a particular corresponding function in accordance with the change in the interval between the plurality of positional coordinates.

Further, the computing module 160 is connected with an external device through a wired or a wireless network. If so, it is possible to control the external device, using the positional coordinates that the spatial touch recognition module 150 recognizes. In other words, when the positional coordinates correspond to a control instruction for the external device, the external device is made to perform the corresponding function.

The external device herein may be a home network appliance or a server connected to the external device by a network.

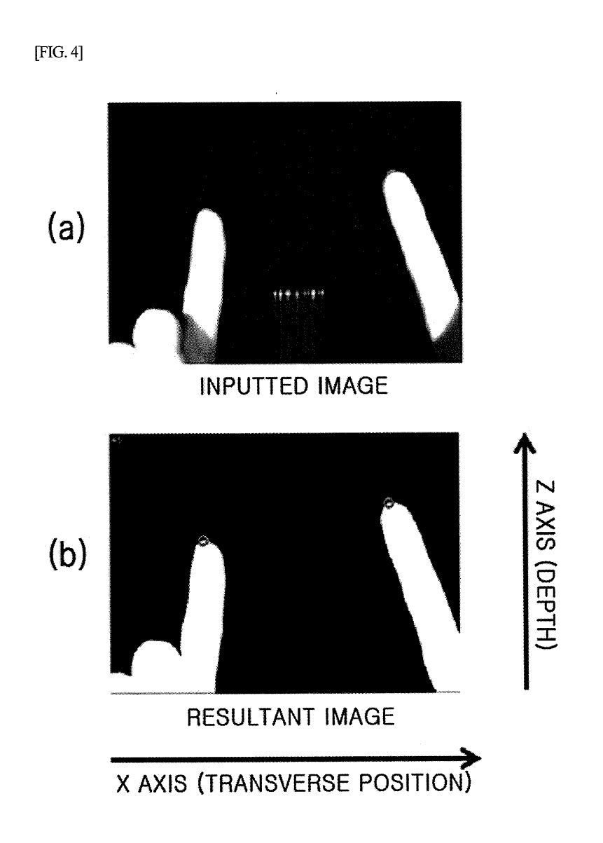

FIG. 4 is a diagram illustrating the principle of recognizing a spatial touch in an apparatus for touching a projection of a 3D image on an infrared screen using a single-infrared camera, in accordance with an embodiment of the present invention and FIG. 5 is a diagram showing the internal configuration of a spatial touch recognition module according to an embodiment of the present invention.

The image photographed by the infrared camera 120 looks black due to the infrared rays, which are emitted from the infrared LED array 110, before a user indication object (user's finger) enters the infrared screen.

However, when the user indication object, that is, the fingertip of the user enters the infrared screen, infrared rays scatter or diffuse, so that the portion where the user indication object is positioned looks bright, as shown in FIG. 4. As a result, it becomes possible to find the X-axial and Z-axial coordinates on the infrared screen touched by the user indication object (fingertip), by performing image processing on the bright portion and then finding the fingertip.

The space touch recognition module 150 includes a difference image acquiring unit 151, a binarizing unit 152, a smoothing unit 153, a labeling unit 154, and a coordinate calculating unit 155.

When receiving an input image inputted from the infrared camera 120, the difference image acquiring unit 151 acquires a difference image (i.e. source image) by performing a subtracting operation that subtracts the pixel value of a background image, which is stored in advance, from the pixel value of the input image.

When receiving the difference image corresponding to a monochrome image as shown in FIG. 5A from the difference image acquiring unit 151, the binarizing unit 152 performs binarizing on the received difference image. In detail, the binarizing unit 152 performs binarizing, which adjusts the pixel values of pixels into 0 (black) when the pixel values of the pixels are not larger than a predetermined threshold value and changes the pixel values of pixels into 255 (white) when the pixel values of the pixels are not smaller than the threshold value, on the difference image.

The smoothing unit 153 removes noise from the binary image by smoothing the binary image binarized by the binarizing unit 152.

The labeling unit 154 performs labeling on the binary image smoothed by the smoothing unit 153. In detail, the labeling unit 154 labels the pixels with the pixel values adjusted to 255. For example, the labeling unit 154 reconstructs the binary image by attaching different numbers to white blobs, using an 8-neighbouring pixel labeling technique. As described above, the labeling operation is a technique widely used in the field of image processing, so that the detailed description is not provided.

The coordinate calculating unit 155 calculates the center coordinates of blobs having a size that is the same or more than a predetermined threshold value in the blobs labeled by the labeling unit 154. In detail, the coordinate calculating unit 155 calculates the center coordinates of the corresponding blobs by considering the blobs having a size that is the same as or more than the threshold value as a finger or an object that touches the infrared screen. The center coordinates can be detected by various detecting methods. For example, the coordinate calculating unit 155 takes the intermediate values of the X-axial and Z-axial minimum values and the X-axial and Z-axial maximum values of the corresponding blob as the center of weight and determines the intermediate values as the corresponding coordinates of the touch.

Further, the coordinate calculating unit 155 can calculate a plurality of center coordinates, when there is a plurality of blobs each having a size that is the same as or more than the threshold value.

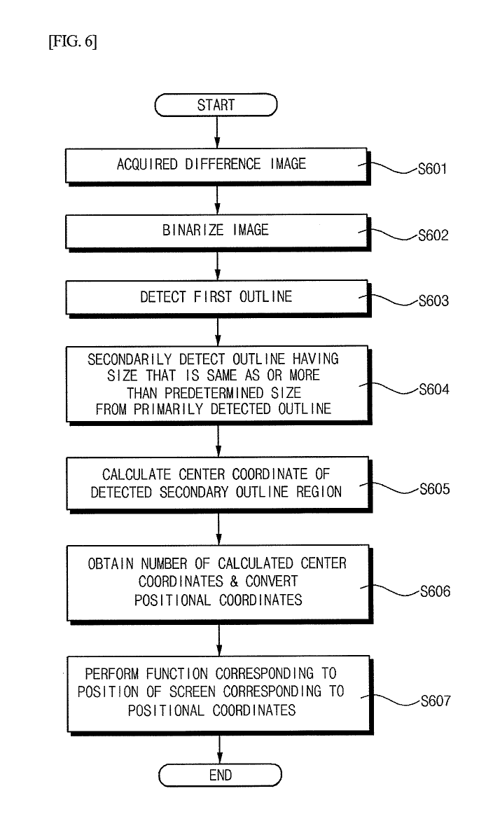

FIG. 6 is a flowchart illustrating a method of recognizing a touch on a projection image in the apparatus for touching a projection of a 3D image on an infrared screen using a single-infrared camera according to an embodiment of the present invention.

First, the spatial touch recognition module 150 acquires a difference image by performing a subtracting operation that subtracts the pixel value of a background image, which is stored in advance, from the pixel value of a camera image, when receiving a monochrome image from the infrared camera 120 in step S601.

Further, the spatial touch recognition module 150 performs binarizing and smoothing on the acquired difference image in step S602.

Subsequently, the space touch recognition module 150 performs labeling on the binarized and smoothed image and detects the outline corresponding to the user indication object (finger) in the labeled blobs, in step S603.

The spatial touch recognition module 150 secondarily detects the outline having a predetermined or more size from the primarily detected outline. Then, in step S604, the spatial touch recognition module 150 calculates the center coordinates of the secondarily detected outline region S605. In this event, the number of secondarily detected contour regions may be plural.

The spatial touch recognition module 150 converts the calculated center coordinates into the center coordinates of the infrared screen, in step S606, and transmits the converted center coordinates to the computing module 160, in step S608.

Subsequently, the computing module 160 performs the function corresponding to the positional information recognized by the spatial touch recognition module 150, in step S607.

An apparatus for touching a projection of a 3d image on an infrared screen using a single-infrared camera according to the present invention is not limited to the embodiment described above and may be modified in various ways without departing from the scope of the present invention.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An apparatus for touching a projection of a 3d image on an infrared screen using a single-infrared camera, comprising:
an infrared Light Emitting Diode (LED) array for generating an infrared screen in a space by emitting infrared rays;
a projector for projecting an image on the infrared screen;
a single infrared camera disposed above or under the center portion of the infrared LED array such that a lens faces the infrared screen; and
a spatial touch recognition module for calculating the X-axial and Z-axial coordinates on the infrared screen touched by a user indication object, using an image photographed by the infrared camera.

2. The apparatus as claimed in claim 1, further comprising:
a pulse generating unit that periodically generates a pulse signal; and
an LED driving unit that supplies direct current power to the infrared LED array when a pulse signal is inputted from the pulse generating unit, and cuts the direct current power supplied to the infrared LED array when a pulse signal is not inputted from the pulse generating unit.

3. The apparatus as claimed in claim 2, wherein the infrared camera takes a photograph when a pulse signal is inputted from the pulse generating unit.

4. The apparatus as claimed in claim 1, wherein the projector comprises:
a display module that displays an image; and
a projection module that projects an image displayed by the display module on the infrared screen.

5. The apparatus as claimed in claim 4, wherein the projection module comprises:
a beam splitter that divides a source beam emitted from the display module into two beams and reflects a beam of the two beams; and
a spherical mirror that reflects the beam reflected from the beam splitter to the beam splitter again.

6. The apparatus as claimed in claim 5, wherein the projection module further comprises a polarizing filter that converts a beam, which is reflected from the spherical mirror and is passing through the beam splitter, into polarized light.
